(19) United States
(12) Patent Application Publication
(10) Pub. No.: US 2017/0254971 A1
(43) Pub. Date: Sep. 7, 2017

(54) OPTICAL CONNECTION MODULE

(71) Applicant: CENTERA Photonics Inc., Hsinchu (TW)

(72) Inventors: Po-Kuan SHEN, Miaoli County (TW); Tzu-Ching YEH, Hsinchu County (TW); Chin-Ta CHEN, Changhua County (TW); Hsiao-Chin LAN, New Taipei City (TW)

(21) Appl. No.: 15/450,027

(22) Filed: Mar. 6, 2017

Related U.S. Application Data
(60) Provisional application No. 62/304,325, filed on Mar. 7, 2016.

(51) Int. Cl. G02B 6/42; G02B 6/32

(52) U.S. Cl. CPC G02B 6/4214; G02B 6/4246; G02B 6/4244; G02B 6/4257; G02B 6/4242; G02B 6/4243; G02B 6/4249; G02B 6/4206; G02B 6/32

(57) ABSTRACT

An optical connection module includes a substrate, a light source, an optical detector, at least one first optical channel, at least one second optical channel, an oblique surface and a light guide device. The light source is disposed on the substrate and is configured to emit a first light. The first optical channel is configured to transmit the first light, and the light guide device is configured to guide the first light propagating from the light source into the first optical channel in a manner of light transmission. The optical detector is disposed on the substrate and is configured to receive a second light. The second optical channel is configured to transmit the second light, and the oblique surface is configured to guide the second light propagating from the second optical channel into the optical detector in a manner of reflection.

### RELATED APPLICATIONS

This application claims priority to U.S. Provisional Application Ser. No. 62/304,325, filed Mar. 7, 2016, which is herein incorporated by reference.

### BACKGROUND

Technical Field

The present disclosure relates to an optical connection module.

Description of Related Art

In recent years, with the increasing, development of optical communication, an optical connection module has drawn much attention. In general, the optical connection module may be disposed in an electronic device and include a transmitting part and a receiving part. A light source of the transmitting part may emit light and transmit optical signals to other devices, and an optical detector of the receiving part may receive light propagated from other devices and detect optical signals, so the optical connection module may serve as a bridge between the electronic device and other devices. However, with the advance of technology, electronic devices are becoming increasingly diverse, and then the optical connection module also tends to be diversified. Therefore, how to improve the flexibility in choosing components of the optical connection module, and maintain an optical coupling efficiency of the optical connection module has become an important research and development issue.

In general, an edge-emitting laser has a high output power suitable for long-haul communications. However, the edge-emitting laser emits lights with large divergence angle, so as to reduce the optical coupling efficiency.

### SUMMARY

The disclosure elates to an optical'connection module, which may increase the flexibility in choosing components of the optical connection module, and improve an optical coupling efficiency of the optical connection module.

In accordance with some embodiments of the present disclosure, an optical connection module includes a substrate, a light source, an optical detector, at least one first optical channel, at least one second optical channel, an oblique surface, and a light guide device. The light source is disposed on the substrate and configured to emit a first light. The first optical channel is configured to transmit the first light. The light guide device is configured to guide the first light propagating from the light source into the first optical channel in a manner of light transmission. The optical detector is disposed on the substrate and configured to receive a second light. The second optical channel is configured to transmit the second light. The oblique surface is configured to guide the second light propagating from the second optical channel into the optical detector in a manner of light reflection.

In accordance with some embodiments of t he present disclosure, the optical connection module further includes a cover plate. The oblique surface is disposed on the cover plate and the second optical channel is fixed between the cover plate and the substrate.

In accordance with some embodiments of the present disclosure, the substrate has a recess, and the optical detector is disposed in the recess.

In accordance with some embodiments of the present disclosure, the substrate has a protrusion portion and a base portion. The protrusion portion protrudes from the base portion, the oblique surface connects the protrusion portion and the base portion, the optical detector is disposed on the protrusion portion, and the second optical channel is disposed on the base portion.

In accordance with some embodiments of the present disclosure, the substrate and the cover plate respectively have a cavity insert or a core insert to form an engagement structure configured to fix the first optical channel or the second optical channel.

In accordance with some embodiments of the present disclosure, the substrate or the cover plate has a plurality of recesses configured to accommodate the first optical channel or the second optical channel.

In accordance with some embodiments of the present disclosure, the substrate has a recess portion, and the light guide device is placed on the recess portion.

In accordance with some embodiments of the present disclosure, the light guide device is a lens. The lens is configured to converge the first light propagating from the light source into the first optical channel.

In accordance with some embodiments of the present disclosure, the light source and the optical detector are disposed on the same edge of the substrate.

In accordance with some embodiments of the present disclosure, an optical connection module includes a substrate, a light source, an optical detector, at least one first optical channel, at least one second optical channel, and an oblique surface. The light source is disposed on the substrate and configured to emit a first light. The first optical channel is configured to transmit the first light. The optical detector is disposed on the substrate and configured to receive a second light. The second optical channel is configured to transmit the second light. The second optical channel has a light input unit and a light output unit, the light input unit and the light output unit are disposed along a first arrangement direction. The oblique surface is configured to guide the second light propagating from the second optical channel into the optical detector. The oblique surface and the optical detector are disposed along a second arrangement direction intersecting with the first arrangement direction.

In accordance with some embodiments of the present disclosure, the optical connection module further includes a light guide device. The light guide is configured to guide the first light propagating from the light source into the first optical channel. A projection of the light guide device on a surface of the substrate is located between a projection of the light source and a projection of the first optical channel on the surface of the substrate,

In the foregoing embodiments, the optical connection module utilizes the light guide device, such that the first light propagating from the light source on the substrate can be guided into the first optical channel. The optical connection module utilizes the oblique surface, such that the second light propagating from the second optical channel can be redirected to the optical detector on the substrate. In other words, the optical coupling efficiency of the optical connection module may be improved by the light guide device and the oblique surface. In terms of the transmitting part, the light guide device may converge the first light after it transmitted from the light source, so the radiation angle, the light intensity and the radiation surface of the light source may not be critical, thereby increasing the flexibility in choosing the light source. In terms of the receiving part, the oblique surface may redirect a propagating direction of the second light, so a receiving surface of the optical detector may not be restricted to be perpendicular to an output light path of the second optical channel, preventing a non-coplanar fold of the electric circuits connected with the optical detector and benefiting to transmit high frequency signals.

It is to be understood that both the foregoing general description and the following detailed description are, by examples, and are intended to provide further explanation of the invention as claimed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is an exploded view of an optical connection module in accordance with some embodiments of the present disclosure.

FIG. 2 is a cross-section view along line 2-2 of the optical connection module of FIG. 1.

FIG. 3 is a cross-section view along of the optical connection module of FIG. 1.

FIG. 4 is a cross-section view of a transmitting part of the optical connection module in accordance with other embodiments of the present disclosure.

FIG. 5 is a cross-section view of a transmitting part of the optical connection module in accordance with other embodiments of the present disclosure.

FIG. 6 is a cross-section view of a receiving part of the optical connection module in accordance with other embodiments of the present disclosure.

### DETAILED DESCRIPTION

Reference will now be made in detail to the present embodiments of the invention, examples of w hick are illustrated in the accompanying drawings. Wherever possible, the same reference numbers are used in t he drawings and the description to refer to the same or parts.

Further, spatially relative terms, such as “beneath,” “below,” “lower,” “above,” “upper” and the like, may be used herein for ease of description to describe one element or feature s relationship to another element(s) or feature(s) as illustrated in the figures. The spatially relative terms are intended to encompass different orientations of the device in use or operation in addition to the orientation depicted in the figures. The apparatus maybe otherwise oriented (rotated 90 degrees or at other orientations) and the spatially relative descriptors used herein may likewise be interpreted accordingly.

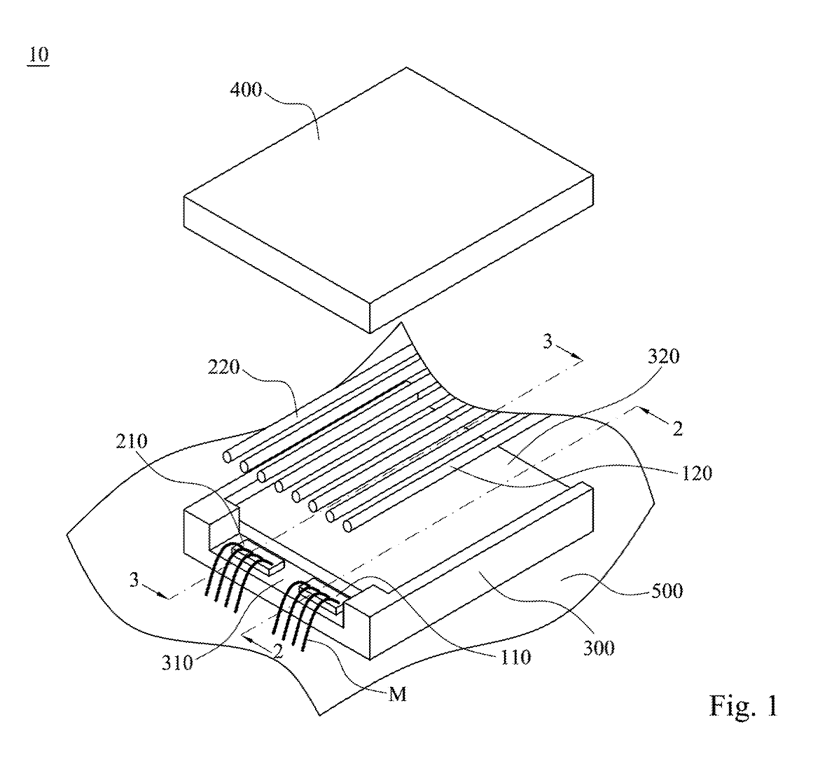

Reference is made to FIG. 1. FIG. 1 i an exploded view of an optical connection module in accordance with some embodiments of the present disclosure. The optical connection module 10 includes a light source 110, a first optical channel 120, an optical detector 210, a second optical channel 220, a substrate 300 and a cover plate 400. The light source 110 and the optical detector 210 are disposed on the substrate 300. More particularly, the light source 110 and the optical detector 210 are disposed on the same substrate. The first optical channel 120 and the second optical channel 220 are fixed between the substrate 300 and the cover plate 400. In some embodiments, the substrate 300 has an engagement structure (not shown in the figure) which may be a concave or convex structure. The cover plate 400 also has an engagement structure (not shown in the figure) disposed correspondingly to a position of the engagement structure of the substrate 300 and being the concave or convex structure corresponding to that, of the substrate 300. For example, the engagement structure of the substrate 300 is a cavity insert, the engagement structure of the cover plate 400 is a core insert, and the core insert of the cover plate 400 may engage the cavity insert of the substrate 300. As a result, the cavity insert of the substrate 300 and the core insert of the cover plate 400 may assist the light source 110 on the substrate 300 in being aligned with the first optical channel 120 and assist the optical detector 210 on the substrate 300 in being aligned with the second optical channel 220, so as to improve an alignment accuracy of the optical connection module 10, benefitting to improve an optical coupling efficiency of the optical connection module 10. In some embodiments, for example, the engagement structures of the cover plate 400 and the substrate 300 may be formed by semiconductor manufacturing processes, such as a photolithograph process or an etching process, but it is not limited thereto. It is noted the device formed by the semiconductor manufacturing technologies is more accurate than that of injection molding processes and stamper processes, and the high accuracy of the engagement structures of the substrate 300 and the cover plate 400 according to the present invention is benefit to reduce the size of the optical connection module 10 Furthermore, through such engagement structures, the substrate 300 and the cover plate 400 are aligned to bond together more efficiently and accurately to fix the first optical channel 120 and the second optical channel 220, so as to benefit from mass production. In some embodiments, for example, the optical channel 120 or 220 may be an optical fiber, a waveguide, or any light-guide elements formed on the substrate 300 or the cover plate 400 by semiconductor manufacturing processes. Besides, the optical channel 120 or 220 may be a discrete component assembled to the substrate 300 or the cover plate 400. In some embodiments, the substrate 300 or the cover plate 400 may have a plurality of recesses (not shown in the figure) for placing and fixing the optical channel 120 or 220.

As shown in FIG. 1, a periphery of the substrate 300 has a first edge 310 and a second edge 320 opposite to each other. In some embodiments, the light source 110 and the optical detector 210 are both disposed on the same edge, for example, on the first edge 310, so the optical connection module 10 is easy to connect two devices. State differently, the devices (not shown in the figure) for connecting to the optical connection module 10 may be disposed adjacent to the first edge 310, benefitting to directly connect the light source 110 and the optical detector 210. The first optical channel 120 and the second optical channel 220 may be disposed across the second edge 320. In some embodiments, at least one portion of the first optical channel 120 and the second optical channel 220 may extend from the first edge 310 to the second edge 320. The first optical channel 120 is disposed within an irradiation range of the light source 110, and the second optical channel 220 is disposed within a detection range of the optical detector 210. The first optical channel 120 is configured to transmit the first light emitted from the light source 110 on the first edge 210. The second optical channel 220 is configured to transmit the second light into the optical detector 210 on the first edge 310, and the first optical channel 120 is substantially parallel to the second optical channel 220. In other words, the first light transmitted by the first optical channel 120 is not intersecting with the second light transmitted by the second optical channel 220. As a result, the optical channels 120 and 220 may prevent the first light and the second light from mutually distributing or crosstalk, and thus the optical connection module 10 can transmit signals more accurately.

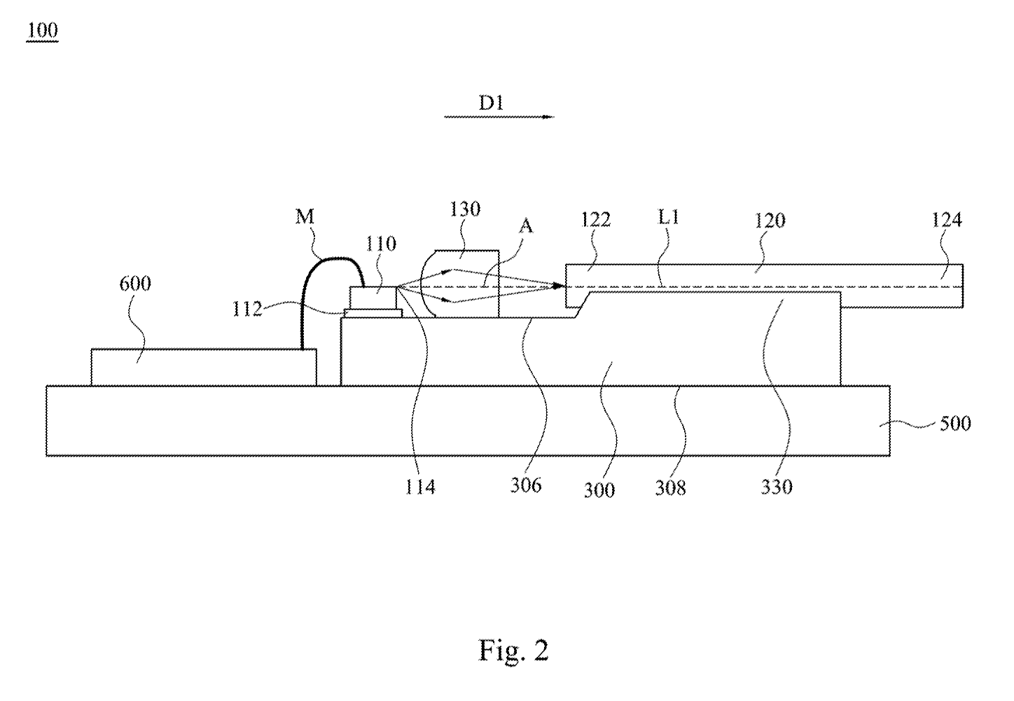

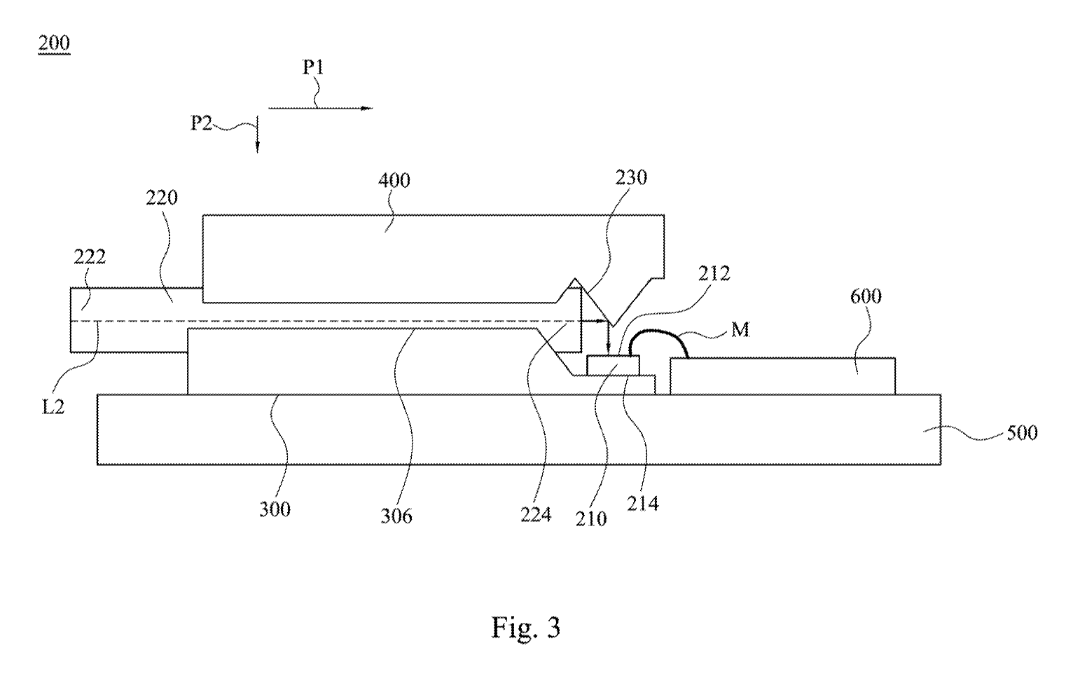

Reference is made to FIG. 2 and FIG. 3. FIG. 2 is a cross-section view along line 2-2 of the optical connection module of FIG. 1. FIG. 3 is a cross-section view along line 3-3 of the optical connection module of FIG. 1. As shown in FIG. 2 and FIG. 3, the optical connection module 10 includes a transmitting part 100 and a receiving part 200. The transmitting part 100 has the light source 110, the first optical channel 120, and a light guide device 130. The receiving part 200 has the optical detector 210, the second optical channel 220, and an oblique surface 230. As shown in FIG. 2, the light source 110 is configured to emit the first light, the first optical channel 120 is configured to transmit the first light, and the light guide device 130 is configured to guide the first light propagating from the light source 110 into the first optical channel 120 in a manner of light transmission. As shown in FIG. 3, the optical detector is configured to receive the second light The second optical channel 220 is configured to transmit the second light, and the oblique surface 230 is configured to guide the second light propagating from the second optical channel 220 into the optical detector 210 in a manner of light reflection. In other words, through the light guide device 130, the transmitting part 100 of the optical connection module 10 may guide the first light into the first optical channel 120, and through the oblique surface 230, the receiving part 200 of the optical connection module 10 may guide the second light into the second optical channel. As a result, the light guide device 130 and the oblique surface 230 may respectively improve the optical coupling efficiency of the transmitting part 100 and the receiving part 200 of the optical connection module 10.

In terms of the transmitting part 100, as shown in FIG. 2, since the light guide device 130 may effectively guide the first, light into the first optical channel 120, a choice of the light source 110 may be more diverse, in some embodiments, for example, the light guide device 130, as a lens, may converge the first light after it transmitted from the light source 110, so the radiation angle, the light intensity and the radiation surface of the light source 110 may not be critical, thereby increasing the flexibility in choosing the light source 110. For example, an edge-emitting laser (EEL) could be used as the light source 110, which is helpful to make the optical connection module 10 applied in a long-haul communication. In some embodiments, the light source 110 may be, but is not limited to be, an electrical-to-optical device or an optical-to-optical device.

As shown in FIG. 2, the substrate 300 includes a top surface 306 and a rear surface 308 opposite to each other, and the top surface is closer to the light guide device 130 than the rear surface 308 being. The light guide device 130 is configured to guide the first light propagating from the light source 110 into the first optical channel 120, and a projection of the light guide device 130 on the top surface 306 is located between a projection of the light source 110 on the top surface 306and a projection of the first optical channel 120 on the top surface 306. In other words, the light source 110, the light guide device 130 and the first optical channel 120 are sequentially disposed on the substrate 300 along a first direction D1. As a result, the first light from the light source 110 may propagate through the light guide device 130 substantially towards the first direction D1, propagating into the first optical channel 120, rather than refracted to another direction, such as perpendicular to or reverse to t he first direction D1.

In some embodiments, the first optical channel 120 includes a light input unit 122 and an opposite light output unit 124, of which the light input unit 122 is closer to the light source 110. The first light is transmitted into light input unit 122 from the light guide device 130, and then leaves the first optical channel 120 through the light output unit 124. In some embodiments, the substrate 300 has the engagement structure 330. The engagement structure 330 is a core insert which may engage the corresponding engagement structure of the cover plate 400 for fixing the first optical channel 120. Since the engagement manufacturing processes, the corresponding position of the substrate 300 and the cover plate 400 may be controlled accurately, so the extension line L1 from the light input unit 122 to the light output unit 124 of the first optical channel 120 is well controlled to be coaxial with an optical axis of the light guide device 130, thereby further improving the optical coupling efficiency as the first light transmitted from the light guide device 130 into the first optical channel 120. In some embodiments, the substrate 300 has a plurality of recesses formed thereon (not shown in the figure) for placing and fixing the first optical channel so as to improve the alignment accuracy of the first optical channel 120.

In some embodiments, the light guide device 130 is a lens, which is configured to converge the first light from the light source 110 into the first optical channel 120. In some embodiments, the light guide device 130 may be a discrete component assembled to the substrate 300, or an integrated component formed on the substrate 300 by the semiconductor manufacturing processes. The light guide device 130 may also be a lens with a positive refractive power, such as a bi-convex lens, a plane-convex lens, or a concave-convex lens, for effectively converge the first light into the first optical channel, but it is not limited thereto. As shown in the FIG. 2, even the light source 110 emitting the first light with large divergence angle, the lens can effectively converge the light beam, adjusting the optical path of the first light, such that the first light can be guided into the light input unit 122 of the first optical channel 120 more accurately, so as to improve the optical coupling efficiency of the optical connection module 10 and increase the flexibility in choosing the light source 110.

The transmitting part 100 may further have a light source stage 112, which is disposed between the light source 110 and the substrate 300 and configured to adjust a level height of the light source 110, so as to assist the light source 110 in being aligning with the light guide device 130, thereby increasing the flexibility in choosing the light source 110. In some embodiments, the thickness of the light source stage 112 is adjustable, and thus the level height of the light source 110 disposed on the light source stage 112 may be varied, so that light source 110, even in different size, may be aligned with the light guide device 130 by the light source stage 112 precisely, and also the light output edge 114 is able to be aligned with the optical axis A of the light guide device 130, so as to further improve the optical coupling efficiency as the first light transmitted from the light source 110 into the light guide device 130.

In terms of the receiving part 200, as shown in FIG. 3, the optical detector 210 has a receiving surface 212 and a rear surface 214 opposite to each other, and the receiving surface 212 is fixed on the substrate 300. In some embodiments, the substrate 300 has a recess, and the optical detector 210 is disposed in the recess. The receiving surface 212 is farther away from the substrate 300 than the rear surface 214 being. At least one portion of the receiving surface 212 is directly under the oblique surface 230, such that the oblique surface 230 may redirect the second light into the receiving surface 212 of the optical detector 210 in a manner of light reflection. Since the oblique surface 210 may effectively redirect the second light into the optical detector, the receiving surface 212 of the optical detector 210 may not be restricted to be perpendicular to the second optical channel 220.. If the receiving surface 212 must be faced to the second optical channel 220, the optical detector 210 should be erectly fixed on the top surface 306, and the bonding wire will be folded in order to connect the driving circuit that is flatly located on the substrate 300 or the circuit board 500, called the non-coplanar fold which will cause the interference in high frequency signal transmission. In other words, the second fight from the second optical channel 200 can be redirected to the optical detector 210 through the oblique surface 230, so as to prevent the electric circuits on the optical detector 210 from being folded in a manner of out of plane, benefiting to transmit high frequency signals:

In some embodiments, the second optical channel 220 includes a light input unit 222 and an opposite light output unit 224, and the light input unit 222 and the light output unit 224 are disposed along a first arrangement direction P1. The light input unit 222 is configured to receive the second light from another device (not shown in the figure), and the second light leaves the second optical channel 220 through the light output unit 224. The oblique surface 230 is farther away from the light input unit 222 than the light output unit 224 being, and the oblique surface 230 and the optical detector 210 are disposed along a second arrangement direction P2, in which the first arrangement direction P1 and the second arrangement direction P2 intersect each other. Therefore, when the second light leaves the light output unit 224 of the second optical channel 220 and then arrives at the oblique surface 230, the second light is reflected, by the oblique surface 230, to the underlying optical detector 210. More particularly, the second light at the oblique surface 230 may be turned about 90 degree, forming a non-coplanar turning, preventing a non-coplanar fold of the electric circuits as aforesaid,

In some embodiments, the substrate 300 includes a top surface 306 and a rear surface 308, and the top surface 306 is closer to the cover plate 400 than the rear surface 308 being. At least one portion of a projection of the oblique surface 230 overlaps with a projection of the optical detector 210 on the substrate 300. The oblique surface 230 is disposed on the cover plate 400, and the second optical channel 220 is fixed between the cover plate 400 and the substrate 300. In FIG. 3, which is similar to FIG. 2, the substrate 300 and the cover plate 400 both have engagement structures (not shown in the figure) For example, the engagement structure of the substrate 300 is a core insert, and the engagement structure of the cover plate 400 is a cavity insert corresponding to the core insert. The engagement structures may accurately fix the second optical channel 220, the oblique surface 230 and the optical detector 210 on appropriate positions. In some embodiments, the cover plate 400 may be silicon, semiconductor material, or ceramics, and the cover plate 400 may form the oblique surface 230 by semiconductor manufacturing processes, such as a photolithograph process or an etching process, but it is not limited thereto. It is noted the device formed by the semiconductor manufacturing technologies may be more accurate than that of injection molding processes and stamper processes, so as to reduce optical length of the second light between the second optical channel 220 and the oblique surface 230, benefitting to reduce the optical loss of the second light. In some embodiments, the substrate 300 or the cover plate 400 may have a plurality of recesses (not shown in the figure) for placing and fixing the second optical channel 220 and further improving the alignment accuracy of the second optical channel 220.

Furthermore, in some embodiments, as shown in FIG. 1 to FIG. 3, the optical connection module 10 further includes a circuit board 500 and a driver 600. The substrate 300 is disposed on the circuit board 500. The driver 600 is disposed on the circuit board 500, and the driver 600 is configured to drive the light source 110 and the optical detector 210 or provide the light source 110 and the optical detector 210 with an electric, signal. The driver 600 and the optical detector 210 may be connected electrically by the wire M. In some embodiments the driver 600 may be, but is not limited to be, a driver IC chip, a control IC chip or a trans-impedance amplifier (TIA) chip.

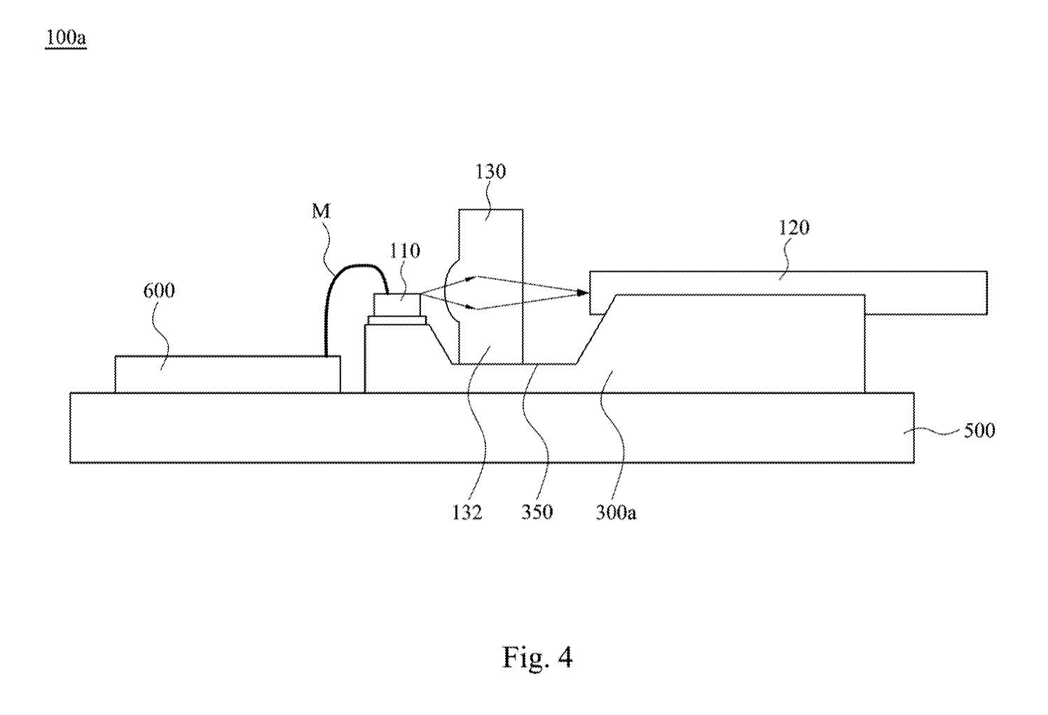

FIG. 4 is a cross-section view of a transmitting part of the optical connection module in accordance with other embodiments of the present disclosure. As shown in FIG. 4, the main difference between this embodiment and the foregoing embodiment is that: a substrate 300a has a recess portion 350, and the light guide device 130 is placed on the recess portion 350. More particularly, as shown in FIG. 4, the light guide device 130 has a base portion 132 disposed in the recess portion 350 of the substrate 300. Since the recess portion 350 may adjust a level height of the base portion 13 of the light guide device 130, so as to adjust a level height of the light guide device 130 correspondingly for being aligned with the first optical channel 120. Therefore, the light guide device 130 may have different sizes and thus increase its selectivity.

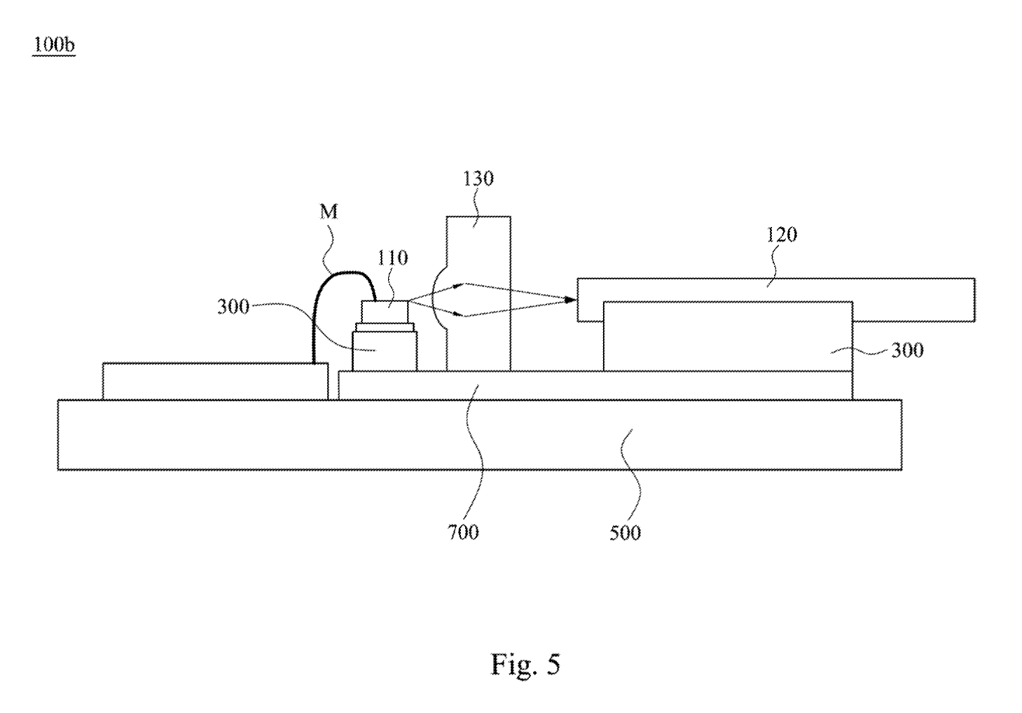

FIG. 5 is a cross-section view of a transmitting part 100b of the optical connection module in accordance with other embodiments of the present disclosure. As shown in FIG. 5, the main difference between this embodiment and the foregoing embodiment is that: the substrate 300 were separated into two parts for bearing the light source 110 and the first optical channel 120 respectively, and the light guide device 130 is disposed between the two parts of the substrate 300. Furthermore, the optical connection module 10 has a carrier 700, of which the two parts of the substrate 300 and the light guide device 130 were arranged in series. The carrier 700 may be a structure made of heat dissipation material, so as to improve the heat dissipation of the carrier 700 and the circuit board 500 connected with the carrier 700.

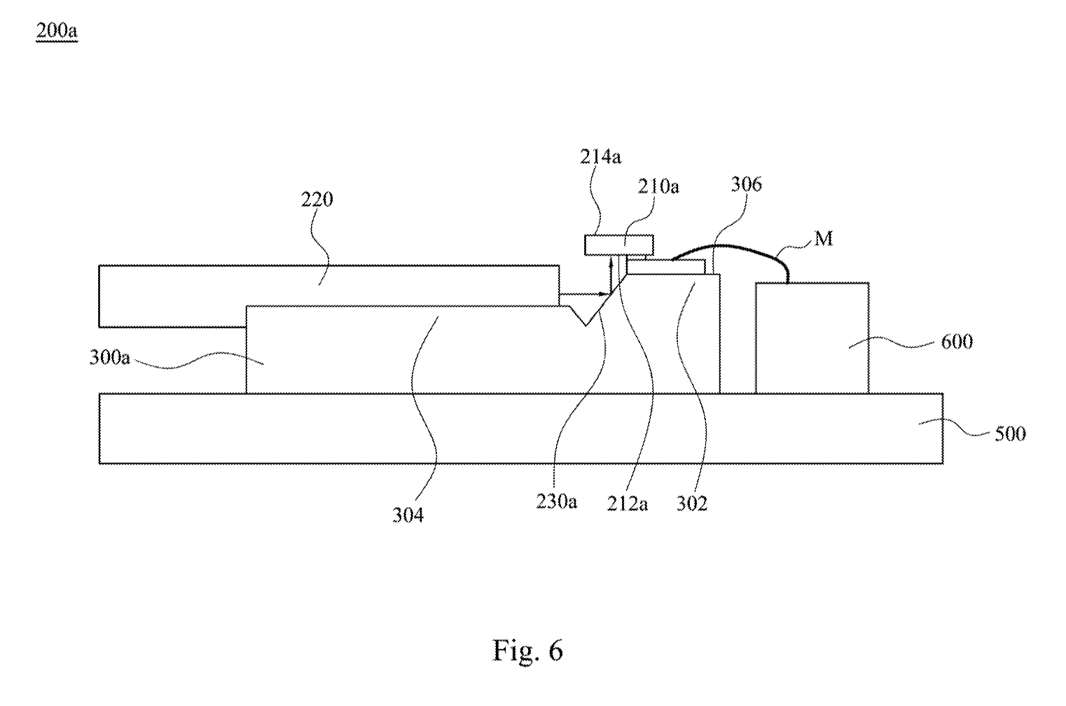

FIG. 6 is a cross-section view of a receiving part of the optical connection module in accordance with other embodiments of the present disclosure. As shown in FIG. 6, the main difference between this embodiment and the foregoing embodiment is that: a substrate 300a has a protrusion portion 302 and a base portion 304. The protrusion portion 302 protrudes from the base portion 304, and an oblique surface 230a connects the protrusion portion 302 and the base portion 304. An optical detector 210a is disposed on the protrusion portion 302, and the second optical channel is disposed on the base portion 304. A receiving surface 212a of the optical detector 210a is closer to the substrate 300a than a rear surface 214a of the optical detector 210a being, and the receiving surface 212a is configured to detect the second light reflected from the second optical channel 220 by the oblique surface 230a.

In the foregoing embodiments, the optical connection module utilizes the light guide device and the oblique surface, respectively, such that the first light can be guided into the first optical channel in a manner of light transmission accurately and the second light can be accurately redirected to the optical detector in a manner of light reflection accurately, so as to improve the optical coupling efficiency of the transmitting part and the receiving part of the optical connection module. In terms of the transmitting part, the light guide device may converge the first light after it transmitted from the light source, so the radiation angle, the light intensity and the radiation surface of the light source may not be critical, thereby increasing the flexibility in choosing the light source 110. In terms of the receiving part, the oblique surface may redirect a propagating direction of the second light, so a receiving surface of the optical detector may not be restricted to be perpendicular to an output light path of the second optical channel, preventing a non-coplanar fold of the electric circuits connected with the optical detector and benefiting to transmit high frequency signals.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An optical connection module, comprising:
a substrate:
a light source, configured to emit a first light, disposed on the substrate;
an optical detector, configured to receive a second light, disposed on the substrate;
at least one first optical channel, configured to transmit the first light;
at least one second optical channel, configured to transmit the second light;
a light guide device, configured to guide the first light propagating from the light source into the first light channel in a manner of light transmission; and
an oblique surface, configured to guide the second light propagating from the second optical channel into the optical detector in a manner of light reflection.

2. The optical connection module of claim 1, further comprising:
a cover plate, wherein the oblique surface is disposed on the cover plate and the second optical channel is fixed between the cover plate and the substrate.

3. The optical connection module of claim 2, wherein the substrate has a recess, and the optical detector is disposed in the recess,

4. The optical connection module of claim 2, wherein the substrate has a protrusion portion and a base portion, the protrusion portion protrudes from the base portion, the oblique surface connects the protrusion portion and the base portion, the optical detector is disposed on the protrusion portion, and the second optical channel is disposed on the base portion.

5. The optical connection module of claim 2, wherein the substrate and the cover plate respectively have a cavity insert or a core insert to form an engagement structure for fixing the first optical channel or the second optical channel.

6. The optical connection module of claim 2, wherein the substrate or the cover plate has a plurality of recesses configured to accommodate the first optical channel or the second optical channel.

7. The optical connection module of claim 1, wherein the substrate has a recess portion, and the light guide device is placed on the recess portion.

8. The optical connection module of claim 1, wherein the light guide device is a lens, configured to converge the first light propagating from the light source into the first optical channel.

9. The optical connection mode e of claim 1, wherein the light source and the optical detector are disposed on the same edge of the substrate.

10. An optical connection module, comprising:
a substrate;
a light source, configured to emit a first light, disposed on the substrate;
an optical detector, configured to receive a second light, disposed on the substrate and;
at least one first optical channel, configured to transmit the first light:
at least one second optical channel, configured to transmit the second light, wherein the second optical channel has a light input unit and a light output unit, the light input unit and the light output unit are disposed along a first arrangement direction; and
an oblique surface, configured to guide the second light propagating from the second optical channel into the optical detector, and the oblique surface and the optical detector are disposed along a second arrangement direction intersecting with the first arrangement direction.

11. The optical connection module of claim 10, further comprising:
a light guide device, configured to guide the first light propagating from the light source into the first optical channel, wherein a projection of the light guide device on a surface of the substrate is located between a projection of the light source and a projection of the first optical channel on the surface of the substrate.
